(19) United States
(12) Patent Application Publication
(10) Pub. No.: US 2015/0028248 A1
(43) Pub. Date: Jan. 29, 2015

(54) DIELECTRIC MATERIAL FOR USE IN ELECTRICAL ENERGY STORAGE DEVICES

(71) Applicant: Robert Bosch GmbH, Stuttgart (DE)

(72) Inventors: Tjalf Pirk, Stuttgart (DE); Thomas Suenner, Stuttgart (DE); Martin Eckardt, Stuttgart (DE); Robert Roelver, Calw-Stammheim (DE); Francisco Hernandez Guillen, Stuttgart (DE)

(21) Appl. No.: 14/374,304

(22) PCT Filed: Dec. 10, 2012
(86) PCT No.: PCT/EP2012/074942

§ 371 Date: Jul. 24, 2014

(30) Foreign Application Priority Data
Jan. 24, 2012 (DE) 10 2012 200 989.2

(51) Int. Cl. H01G 4/08; H01G 4/10

(52) U.S. Cl. CPC H01G 4/08; H01G 4/10
USPC 252/62.3 E

(57) ABSTRACT

A dielectric material for use in electrical energy storage devices includes at least two nanostructures which are each embedded in an electrically insulating matrix made of a material having a bandgap greater than a material of the nanostructures. A probability different from zero of charge carrier tunnelling in parallel to a direction of an electrical field that can be used from outside is set between the two nanostructures.

### PRIOR ART

The present invention relates to a dielectric material as per the preamble of claim 1 and also to an electrical energy storage device comprising such a dielectric material. Advantageous configurations of the invention are indicated in the dependent claims.

The storage of energy is a central technical problem of high importance for a wide range of applications, such as electric vehicles, mobile communication, laptops or the intermediate storage of regenerative energies.

Assuming a linear, isotropic medium with a relative permittivity εᵣ in a field-filled volume V of the energy storage device, the energy Wₑₗ stored in an electric field of an energy storage device can be given by the following expression (ε₀: permittivity of the vacuum):

Wₑₗ=½∫dV ε₀ εᵣ |E|²,

where |E| represents the magnitude of the electric field in the volume element dV.

Current solutions of electrical energy storage devices have a relatively high storage density to dead weight ratio (200-300 Wh/kg), but also low charging and discharging speeds.

By contrast, what are termed supercapacitors or ultracapacitors (“super-caps”) are distinguished by very fast charging and discharging times and also a considerably higher service life. However, the storage density is still typically an order of magnitude below that of electrochemical batteries.

It has been proposed to use materials having a high electrical permittivity εᵣ for the improved storage of electrical energy. Furthermore, solutions with an increase in the effective electrode area and the use of nanostructures embedded in dielectric layers have been proposed. An energy storage device of this type is described, for example, in the document US 2010/0183919 A1.

### DISCLOSURE OF THE INVENTION

The present invention relates to a dielectric material for use in electrical energy storage devices, said material comprising at least two nanostructures each embedded in an electrically insulating matrix made of a material which has a greater band gap than a material of the nanostructures.

It is proposed that a non-zero probability of charge carrier tunneling between the two nanostructures is set parallel to a direction of an externally applicable electric field. The indication of a “parallel direction” should in this context in particular also include the opposite, anti-parallel direction.

As a result, with a suitable design it is possible to provide a high polarizability of the dielectric material combined with a high dielectric strength, i.e. a high maximum electric field strength in an electrical energy storage device. By way of example, when the dielectric material is used in a capacitor, it is possible to combine the advantages of an Li ion battery (high energy storage density) with those of a supercapacitor or ultracapacitor (fast charging and discharging, high cycle capacity). In addition, the dielectric material proposed is distinguished by a low dependency on temperature.

In addition to the use for storing energy, capacitors comprising the proposed dielectric material with a high dielectric strength are also readily suitable for use in high-voltage applications, applications for voltage conversion, in particular by DC-DC converters (“charge pumps”), and also further fields of application such as filter applications, which benefit from high voltages and capacitances in a small space.

Advantageously, the nanostructures can be formed by quantum wells, quantum wires or quantum dots.

Moreover, it is proposed that the dielectric material comprises a plurality of nanostructures, which form a nanostructure chain in the direction of the externally applicable electric field, wherein, between in each case two nanostructures adjacent in the direction of the electric field, a non-zero probability of tunneling of the charge carriers between the nanostructures is set parallel to the direction of the electric field. Since the applied field strength acts on a series connection of the plurality of nanostructures, it is possible to achieve a high dielectric strength with a suitable design.

If at least three nanostructures embedded in in each case an insulating matrix are arranged in succession in the direction of the externally applicable electric field, it is advantageously possible to achieve a particularly high dielectric strength.

Furthermore, it is proposed that the probabilities of the tunneling of the charge carriers between the nanostructures are set so as to rise monotonously or decrease monotonously parallel to the direction of the electric field. It is thereby possible to avoid a premature saturation behavior of the permittivity of the dielectric material in the event of an increase in the externally applicable field strength and to achieve an increased storage capacity for electrical energy.

This is the case to a particular extent when the probabilities of tunneling of the charge carriers between the nanostructures are set so as to rise strictly monotonously or decrease strictly monotonously parallel to the direction of the electric field. In this context, “strictly monotonously” is to be understood as meaning in particular that a first probability of tunneling of the charge carriers between two nanostructures adjacent in the direction of the applicable field strength is unequal to a second probability of tunneling of the charge carriers between two nanostructures of which at least one nanostructure can be distinguished from the former nanostructures. In particular, a strictly monotonous rise or decrease in the probability of tunneling of the charge carriers can achieve defined, reproducible tunneling of the charge carriers.

The probabilities of the tunneling of the charge carriers between the nanostructures can be set parallel to the direction of the electric field by introducing separating layers of differing layer thickness or differing material composition between the nanostructures and/or through nanostructures of differing extent or differing material composition. The setting of the probabilities can also consist of a combination of these parameters. In order to obtain a macroscopic dielectric material, sequences of nanostructures embedded in an electrically insulating matrix can be repeated, and if appropriate can be separated by suitable separating layers.

Moreover, it is proposed that at least one of the nanostructures consists essentially of a doped semiconductor material. In this context, “doping” of the semiconductor material is to be understood as meaning in particular that the semiconductor material is mixed in a manner common in semiconductor technology with dopant atoms, which appear to be suitable to a person skilled in the art, in a concentration of less than 100 ppm. Suitable semiconductor materials are, for example, silicon Si, gallium arsenide GaAs, germanium Ge, silicon carbide SiC and gallium nitride GaN, but also other materials which appear to be expedient to a person skilled in the art and combinations thereof. In this context, “essentially” is to be understood as meaning in particular that the nanostructure consists of the doped semiconductor material in a proportion of advantageously at least 70 atom %, preferably at least 80 atom % and particularly preferably at least 90 atom %. In particular, however, the nanostructure can also consist entirely of the doped semiconductor material.

The field-dependent dipole required for a high permittivity is in this case formed by movable charge carriers of the dopant atoms and ionized dopant atoms and can extend over various nanostructures, as a result of which it is possible to achieve a high polarization. By way of example, in the case of doped quantum dots these can be electrons as majority charge carriers of an n-doped nanostructure and ionized, positively charged dopant atoms. In the field-free case, the freely movable electrons and the stationary dopant atoms are distributed uniformly, and the dielectric material is dipole-free. In the event of an increase in the applied electric field strength, charge carriers begin to tunnel from the nanostructure into an adjacent structure, as a result of which an electric dipole is formed in a desired manner.

It is particularly advantageous that the insulating matrix consists essentially of a material selected from a group consisting of silicon oxide SiO₂, aluminum oxide Al₂O₂, silicon nitride SiN, silicon carbide SiC, gallium nitride GaN and any desired combination of these materials, by virtue of which an insulating energy barrier with respect to the material of the nanostructures can be realized in a particularly simple and varied manner. In this context, “essentially” is to be understood in the same way as that described above.

### DRAWING

Further advantages emerge from the following description of the drawing. The drawing shows exemplary embodiments of the invention. The drawing, the description and the claims contain numerous features in combination. A person skilled in the art will also expediently consider the features on their own and combine them to give expedient further combinations.

In the drawing:

FIG. 1 shows a schematic illustration of an energy storage device comprising a dielectric material according to the invention,

FIGS. 2a-2c show a schematic illustration of energy conditions of a nanostructure chain made up of four nanostructures, and

FIG. 3 shows a theoretical charging and discharging curve of the energy storage device shown in FIG. 1.

### DESCRIPTION OF THE EXEMPLARY EMBODIMENTS

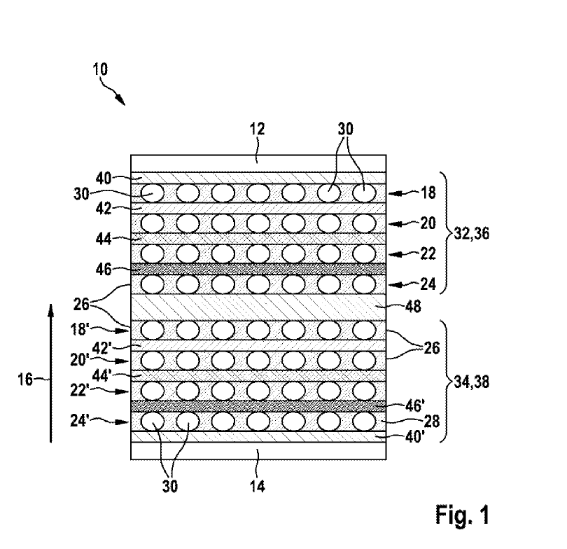

FIG. 1 shows a schematic illustration of an electrical energy storage device 10 comprising a dielectric material according to the invention in a lateral sectional view. The dielectric material is arranged between two plate-shaped, metallic electrodes 12, 14, which extend parallel to one another and perpendicularly to the plane of the drawing. A potential difference can be applied between the electrodes 12, 14 through contact with a voltage source (not shown) and can be used to generate substantially between the electrodes 12, 14 an externally applicable electric field having a direction 16 oriented perpendicular to parallel plate planes of the electrodes 12, 14 and, as per common convention, from a site of higher electric potential to a site of lower electric potential.

The dielectric material comprises a plurality of nanostructures 18, 20, 22, 24 in eight layers 26, the layers 26 each having a nanostructure 18, 20, 22, 24 which is formed by quantum dots 30 of silicon clusters and which is embedded in an electrically insulating matrix 28. The eight layers 26 are arranged one above another in two stacks 32, 34 of identical construction each comprising four layers 26 in the direction of the externally applicable electric field. The layers 26 are in the form of rectangular plates and run parallel to the electrodes 12, 14. The quantum dots 30 are arranged at periodic intervals (not shown) in the plane of the respective layer 26 in two non-parallel directions oriented parallel to the plane.

The electrically insulating matrix 28 of the eight layers 26 consists essentially, to be precise in particular entirely, of silicon oxide SiO₂. The nanostructures 18, 20, 22, 24 consist of n-doped silicon. The electrically insulating matrix 28 therefore has a greater band gap than the material of the nanostructures 18, 20, 22, 24.

Between the eight layers 26 and also between the electrodes 12, 14 and the layer 26 facing toward each electrode 12, 14, the electrical energy storage device 10 has in each case a separating layer 40, 42, 44, 46, 48 which is in the form of a rectangular plate and consists of aluminum oxide Al₂O₃. In this case, a layer thickness of the separating layers 42, 44, 46 decreases in the direction of the electric field. Between two nanostructures 18, 20, 22, 24 in succession in the direction 16 of the electric field, a non-zero probability of tunneling of charge carriers, which are formed by electrons, between the two nanostructures 18, 20, 22, 24 is set. The four nanostructures 18, 20, 22, in each of the two stacks 32, 34 of identical construction in each case form a nanostructure chain 36, 38, in which, between in each case two nanostructures 18, 20, 22, 24 adjacent in the direction of the electric field, a non-zero probability of tunneling of the charge carriers between the nanostructures 18, 20, 22, 24 is set parallel to the direction 16 of the electric field. By virtue of the layer thickness of the separating layers 40, 42, 44, 46 decreasing in the direction 16 of the electric field, the probabilities of the tunneling of the charge carriers between the adjacent nanostructures 18, 20, 22, 24 rise monotonously in the direction 16 of the electric field.

The separating layer 48 which is arranged between the two stacks 32, 34 of identical construction each comprising four layers 26 is designed with the greatest layer thickness, and therefore an energy barrier 56 which is many times greater than the energy barriers 50, 52, 54 formed by the other separating layers 40, 42, 44, 46 is formed between the two stacks 32, 34, and a probability of the tunneling of the charge carriers through the separating layer 48 between the two stacks 32, 34 can be assumed to be zero for practical purposes.

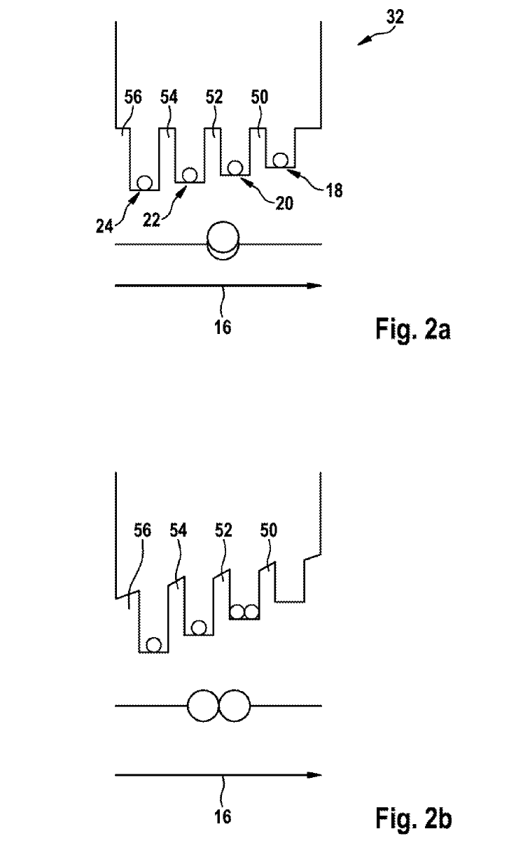

The mode of operation of the dielectric material is explained schematically in FIGS. 2a to 2c. By virtue of the separating layer 48 between the two stacks 32, 34 each comprising four nanostructures 18, 20, 22, 24, which does not allow tunneling of the charge carriers between the stacks 32, 34, the two stacks 32, 34 can be considered to be independent of one another in terms of an illustration in FIG. 2.

FIG. 2a shows the stack 32 made up of four nanostructures 18, 20, 22, 24 in an illustration of the energy depending on the site in a state without an externally applied electric field. It can be seen that the individual nanostructures 18, 20, 22, 24 are separated from one another in terms of energy by energy barriers 50, 52, 54, which decrease in the direction 16 of an applicable electric field. In this field-free case, the electrons and the dopant atoms are distributed uniformly. The dielectric material is not polarized and is dipole-free. A degree of the polarization is indicated in the bottom parts of FIGS. 2a-2c by positions of charge concentrations.

FIG. 2b shows the dielectric material in a state with an externally applied, relatively small electric field in the direction 16. The application of the electric field displaces the energy bands which contain the quantum dots 30. The displacement firstly allows for only the tunneling through that energy barrier 50 between quantum dots 30 which has the smallest height. As a result, the stationary and mobile electrical charges of the first quantum dot 30 are separated, and the dielectric material is in a partially polarized state.

FIG. 2b shows the dielectric material in a state in which the externally applied electric field brings about maximum polarization in the direction 16 and the movable charges have tunneled substantially completely to the quantum dot 30 lying deepest in terms of energy.

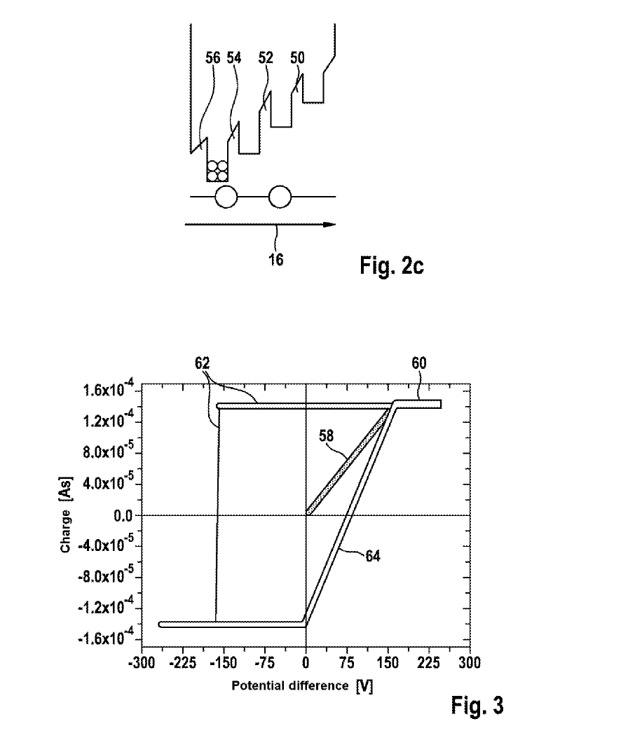

FIG. 3 shows a theoretical charging and discharging curve of the energy storage device 10 shown in FIG. 1 with an assumed area of the electrodes 12, 14 of 1 cm² and a spacing between the electrodes 12, 14 of 1 μm, the dielectric material of which reaches a relative permittivity εᵣ of 1000 in the state of greatest polarization. Proceeding from a state of equilibrium as shown in FIG. 2a, the polarization increases in the curve portion 58 until the state shown in FIG. 2c has been reached. In the curve portion 60 which arises as a result of a further increase in the electric field, there is a saturation, in which the charge no longer rises.

During a discharging operation, which is reproduced by a further curve portion 62, the polarization of the dielectric material initially does not change, since all of the charge carriers are trapped in the quantum dot 30 lying deepest in terms of energy. When a critical strength of the electric field is reached, all of the charge carriers leave the quantum dot 30 lying deepest in terms of energy, and there is a sudden reversal in the polarization of the dielectric material (curve portion 62). When a positive electric field strength is reached between the electrodes 12, 14, the movable charge carriers begin again to tunnel to the adjacent nanostructure 18, 20, 22, 24 formed by quantum dots 30 (curve portion 64).

1. A dielectric material for use in electrical energy storage devices, said material comprising:
at least two nanostructures each embedded in an electrically insulating matrix made of a material which has a greater band gap than a material of the nanostructures,
wherein a non-zero probability of charge carrier tunneling between the at least two nanostructures is set parallel to a direction of an externally applicable electric field.

2. The dielectric material as claimed in claim 1, wherein:
the at least two nanostructures includes a plurality of nanostructures, which form a nanostructure chain in the direction of the externally applicable electric field, and
between in each case two nanostructures adjacent in the direction of the electric field, a non-zero probability of tunneling of the charge carriers between the nanostructures is set parallel to the direction of the electric field.

3. The dielectric material as claimed in claim 2, wherein at least three nanostructures embedded in in each case an insulating matrix are arranged in succession in the direction of the externally applicable electric field.

4. The dielectric material as claimed in claim 1, wherein probabilities of the tunneling of the charge carriers between the at least two nanostructures are set so as to rise monotonously or decrease monotonously parallel to the direction of the electric field.

5. The dielectric material as claimed in claim 1, wherein at least one of the at least two nanostructures includes a doped semiconductor material.

6. The dielectric material as claimed in claim 1, wherein the insulating matrix includes a material selected from silicon oxide SiO₂, aluminum oxide Al₂O₃, silicon nitride SiN, silicon carbide SiC, gallium nitride GaN and any desired combination of these materials.

7. An electrical energy storage device, comprising:
a dielectric material including at least two nanostructures each embedded in an electrically insulating matrix made of a material which has a greater band gap than a material of the nanostructures,
wherein a non-zero probability of charge carrier tunneling between the at least two nanostructures is set parallel to a direction of an externally applicable electric field.
